(19) United States
(12) Patent Application Publication
(10) Pub. No.: US 2020/0361166 A1
(43) Pub. Date: Nov. 19, 2020

(54) TIRE VULCANIZING MOLD AND METHOD FOR MANUFACTURING TIRE

(71) Applicant: Toyo Tire Corporation, Itami-shi (JP)

(72) Inventor: Isao Yonetsu, Itami-shi (JP)

(73) Assignee: Toyo Tire Corporation, Itami-shi (JP)

(21) Appl. No.: 16/814,059

(22) Filed: Mar. 10, 2020

(30) Foreign Application Priority Data
May 17, 2019 (JP) 2019-093397

(51) Int. Cl. B29D 30/06; B29C 33/42; B29D 30/72

(52) U.S. Cl. CPC B29D 30/0606; B29C 33/424; B29D 2030/726; B29D 2030/0612; B29D 2030/0616; B29D 30/72

(57) ABSTRACT

A front surface of a stencil plate to be mounted on a mounting groove of a tire vulcanizing mold is provided with: a first recess for forming a protruding identification mark on an outer surface of a tire; and a second recess on which a screw having a flat head bottom surface is disposed, the second recess being formed on a periphery of a through hole. A back surface of the stencil plate is provided with: a first protrusion corresponding to the first recess and protruding toward a groove bottom surface; and a second protrusion corresponding to the second recess and having a flat surface capable of being brought into surface contact with the groove bottom surface. When a protrusion amount of the first protrusion is H1 (mm), and a protrusion amount of the second protrusion is H2 (mm), 0≤H2−H1 is satisfied.

### BACKGROUND OF THE INVENTION

### Field of the Invention

The present disclosure relates to a tire vulcanizing mold in which a stencil plate is mounted onto a tire molding surface, and to a method for manufacturing a tire, which vulcanizes and molds a tire by using the tire vulcanizing mold.

### Description of the Related Art

On an outer surface of a pneumatic tire, there is formed an identification mark including characters and symbols, which indicate a tire size, a load index, a manufacturer name, a year and week of manufacture, and the like. As described in Patent Documents 1 to 4, a stencil plate (also referred to as a “serial plate”) formed of a metal thin plate is sometimes used in order to form the identification mark. On the stencil plate, protrusions and recesses, which correspond to the identification mark, are formed by embossing and the like. An unvulcanized tire is thrust against the stencil plate attached onto a mounting groove of a tire molding surface in a tire vulcanizing mold, and the identification mark is formed by transcription on a surface of such a tire already vulcanized and molded.

### PRIOR ART DOCUMENTS

### Patent Documents

Patent Document 1: JP-A-2014-133402

Patent Document 2: JP-A-2014-172360

Patent Document 3: JP-A-2018-149744

Patent Document 4: JP-A-2007-038528

### SUMMARY OF THE INVENTION

FIG. 8A illustrates a mounting groove 20 formed on a tire molding surface in a tire vulcanizing mold, a stencil plate 8 that is not yet mounted on the mounting groove 20, and countersunk screws 9 for fixing the stencil plate 8 to the mounting groove 20. The mounting groove 20 has a size enough to fit the stencil plate 8 therein. On a groove bottom surface 21 of the mounting groove 20, female screw holes 25 for fitting the countersunk screws 9 therein are provided. In the countersunk screws 9, bottom surfaces 91 of screw heads are formed into a tapered shape.

The stencil plate 8 has a front surface 81 facing a cavity 87, and a back surface 82 facing the groove bottom surface 21. On the front surface 81, recesses (83, 84) for forming the identification mark are provided. In accordance with this, a protruding identification mark is formed on the outer surface of the tire. The stencil plate 8 is fabricated by embossing by using a metal thin plate. Therefore, on the back surface 82, protrusions (85, 86) are provided so as to correspond to the recesses (83, 84). As described above, in the stencil plate 8 for forming the protruding identification mark on the outer surface of the tire, the protrusions (85, 86) which protrude toward the groove bottom surface 21 are provided.

Moreover, on end portions 8a in a longitudinal direction of the stencil plate 8 (that is, in a crosswise direction of FIG. 8A), there are provided through holes 89 into which the countersunk screws 9 are inserted, and draws 88 formed into a tapered shape so as to go along the bottom surfaces 91. The draws 88 function as recesses, each of which houses at least a part of the screw head portion. On the mounting groove 20, countersinks 24 which abut against back surfaces of the draws 88 of the stencil plate 8 are provided. The countersinks 24 function as recesses, each of which houses a part of the draw 88 of the stencil plate 8.

A worker attaches the countersunk screws 9, which are inserted through the through holes 89, into the female screw holes 25, thereby mounting the stencil plate 8 on the mounting groove 20. Here, for example, when the worker tightens the countersunk screws 9 too strongly, the draws 88 enter the countersinks 24, and the stencil plate 8 is pulled into the groove bottom surface 21 excessively. As a result, as illustrated in FIG. 8B, there sometimes occurs warping of the stencil plate 8, in which the end portions 8a of the stencil plate 8 approach the groove bottom surface 21 from expected positions, and in which a central portion of the stencil plate 8 in a longitudinal direction floats up from the protrusions 85 close to the end portions 8a, the protrusions 85 being taken as fulcrums. For reference, FIG. 8B illustrates, by a broken line BL, the already mounted stencil plate in which no warping occurs, and to which the screws are tightened with appropriate torque.

When the stencil plate 8 is warped, a gap is generated between the stencil plate 8 and the mounting groove 20. Then, at the time of the vulcanization and the molding, there is a possibility that rubber may enter the mounting groove 20 through this gap, leading to a degradation of an exterior appearance of the vulcanized and molded tire.

The present disclosure has been made in view of the actual circumstances described above, and it is an object of the present disclosure to provide a tire vulcanizing mold having a stencil plate in which the possibility of degradation of the exterior appearance of the tire is reduced, and to provide a method for manufacturing a tire, the method using the tire vulcanizing mold.

The above object can be achieved by the present disclosure as described below. Specifically, a tire vulcanizing mold according to the present disclosure includes:

a tire molding surface to be brought into contact with an outer surface of a tire set in a cavity;

a mounting groove provided on the tire molding surface;

a stencil plate to be mounted on the mounting groove; and

a screw having a flat head bottom surface, the screw serving for fixing the stencil plate,

wherein the stencil plate includes: a front surface facing the cavity; a back surface facing a groove bottom surface of the mounting groove; and a through hole through which the screw is inserted from the front surface to the back surface,

the front surface is provided with: a first recess for forming a protruding identification mark on the outer surface of the tire; and a second recess on which the head bottom surface of the screw is disposed, the second recess being formed on a periphery of the through hole,

the back surface is provided with: a first protrusion protruding toward the groove bottom surface in a region corresponding to the first recess; and a second protrusion protruding toward the groove bottom surface in a region corresponding to the second recess and having a flat surface capable of being brought into surface contact with the groove bottom surface,

and when a protrusion amount of the first protrusion is H1 (mm), and a protrusion amount of the second protrusion is H2 (mm), 0≤H2−H1 is satisfied.

In accordance with the present disclosure, the protrusion amount of the second protrusion is equal to or more than the protrusion amount of the first protrusion, and accordingly, the second protrusion can be reliably brought into contact with the groove bottom surface. Moreover, the screw having a flat head bottom surface is used for fixing the stencil plate, and the second protrusion has the flat surface capable of being brought into surface contact with the groove bottom surface. Accordingly, even if the screw is tightened, only a force to sandwich the stencil plate between the bottom surface of such a screw head and the groove bottom surface is increased, and the stencil plate is not pulled into the groove bottom surface. That is, even if a worker tightens the screw having a flat head bottom surface too strongly, the stencil plate can be suppressed from approaching the groove bottom surface from an expected position.

Hence, warping of the stencil plate, in which a central portion of the stencil plate in a longitudinal direction floats up, is reduced, and a gap between the stencil plate and the mounting groove can be reduced. Hence, at the time of the vulcanization and the molding, rubber becomes difficult to intrude from this gap into the mounting groove, and thus, the possibility of degradation of the exterior appearance of the tire can be reduced.

Moreover, it is preferred that H2−H1≤0.3 be satisfied. At the time of the vulcanization and the molding, a pressing force of rubber sometimes bends the stencil plate, and when the stencil plate is bent, unnecessary level difference occurs on the outer surface of the tire, leading to the deterioration of the exterior appearance of the tire. However, when the remaining value obtained by subtracting the protrusion amount H1 of the first protrusion from the protrusion amount H2 of the second protrusion is 0.3 mm or less, the first protrusion contacts the groove bottom surface while the stencil plate is only slightly bent, and a further bend of the stencil plate is suppressed. Then, the occurrence of the unnecessary level difference on the outer surface of the tire is suppressed, and the possibility of degradation of the exterior appearance of the tire can be reduced.

Moreover, when the stencil plate is viewed from the front surface, an outer edge of the second recess may have a U shape including: a circular arc; and a pair of sides individually extending from both end portions of the circular arc along long sides of the stencil plate to an end portion outer edge of the stencil plate. Thus, a space in the second recess, which is not occupied by the head of the screw having a flat head bottom surface, is reduced, and an amount of the rubber flowing into the second recess is reduced, whereby the possibility of degradation of the exterior appearance of the tire can be reduced.

Furthermore, when the stencil plate is viewed from the front surface, an outer edge of the second recess may have a closed shape of not contacting an outer edge of the stencil plate. Thus, an extra gap due to the second recess is not formed between the stencil plate and the mounting groove, and accordingly, the intrusion of rubber is suppressed, whereby the possibility of degradation of the exterior appearance of the tire can be reduced.

A method for manufacturing a tire according to the present disclosure includes: a step of vulcanizing and molding a tire by using the tire vulcanizing mold described above. In accordance with this, the possibility of degradation of the exterior appearance of the tire can be reduced.

### BRIEF DESCRIPTION OF THE DRAWINGS

FIG. 1 is a cross-sectional view of a tire vulcanizing mold, taken along a tire meridian cross section;

FIG. 2 is a plan view viewed from arrow X in FIG. 1;

FIG. 3A is a cross-sectional view along line A-A in FIG. 2;

FIG. 3B is a view illustrating a state in which screws having flat bottom surfaces, a stencil plate and a mounting groove separate from one another before the stencil plate is mounted;

FIG. 4 is a perspective view of a stencil plate according to a first embodiment;

FIG. 5 is a perspective view of a stencil plate according to a second embodiment;

FIG. 6 is a perspective view of a stencil plate according to a third embodiment;

FIG. 7 is a perspective view of a stencil plate according to a fourth embodiment;

FIG. 8A is a view illustrating a state in which countersunk screws, the stencil plate and a mounting groove separate from one another before the stencil plate is mounted in a conventional tire vulcanizing mold; and

FIG. 8B is a view illustrating a problem of the conventional tire vulcanizing mold.

### DETAILED DESCRIPTION OF THE PREFERRED EMBODIMENTS

### First Embodiment

Hereinafter, embodiments of the present disclosure will be described with reference to the drawings. Note that, in the respective drawings, dimensional ratios in the drawings and actual dimensional ratios do not necessarily coincide with each other, and moreover, dimensional ratios between the respective drawings do not necessarily coincide with one another.

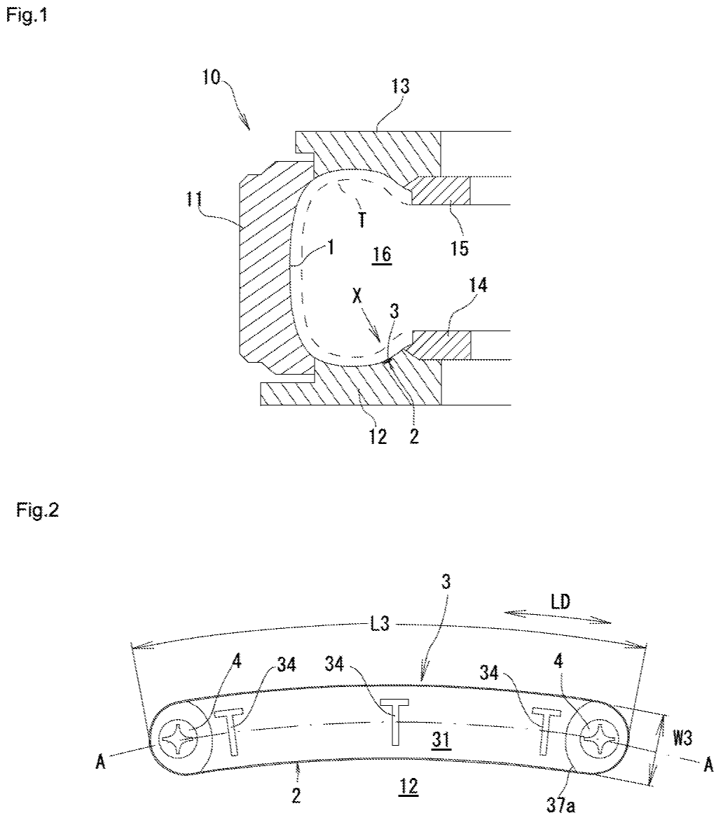

FIG. 1 illustrates a cross section of a tire vulcanizing mold 10 (hereinafter, sometimes simply referred to as a “mold 10”), taken along a tire meridian cross section. This mold 10 is in a closed state. A tire T is set so that a tire width direction is aligned with a vertical direction. In FIG. 1, a left direction is an outside in a tire radial direction, and a right direction is an inside in the tire radial direction.

The mold 10 includes: a tread mold 11 configured to mold a tread of the tire T; a pair of side molds (12, 13) configured to mold sidewalls of the tire T; and a pair of bead rings (14, 15) to which beads of the tire T are to be fitted. The mold 10 includes a tire molding surface 1 to be brought into contact with an outer surface of the tire T set in a cavity 16. The tire molding surface 1 includes an inner surface of the tread mold 11, inner surfaces of the side molds (12, 13), and inner surfaces of the bead rings (14, 15). Although not shown, on the inner surface of the tread mold 11, there is formed an irregular portion for forming a tread pattern on a tread surface of the tire T.

An aluminum member is illustrated as a material of the inner surface of the tread mold 11. This aluminum member is a concept including not only a pure aluminum-based material but also an aluminum alloy, and examples of the aluminum member include Al—Cu-based, Al—Mg-based, Al—Mg—Si-based, Al—Zn—Mg-based, Al—Mn-based, and Al—Si-based materials. As a material of the inner surfaces of the side molds (12, 13) and the bead rings (14, 15), a steel material such as a rolled steel for general structure (for example, SS400 (JIS Standard)) is illustrated.

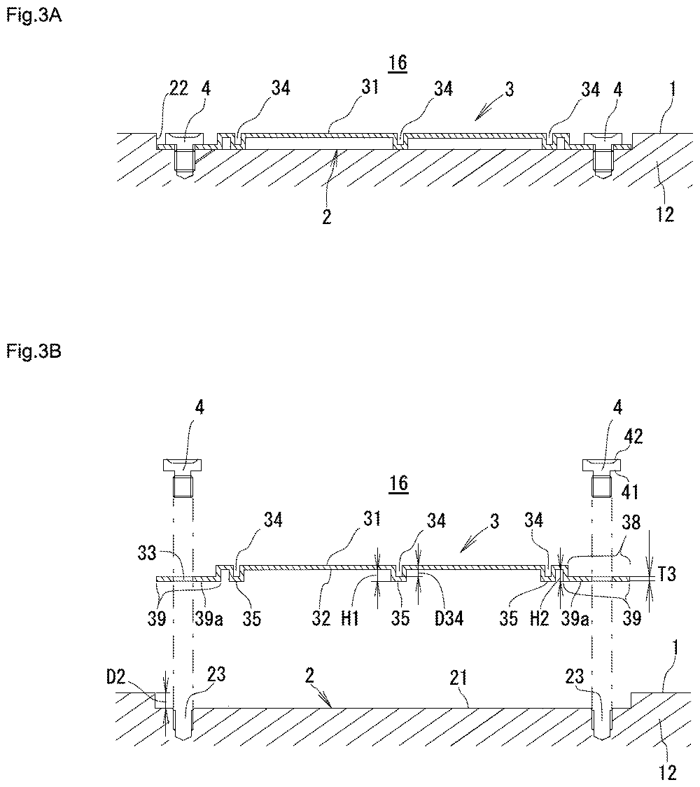

FIG. 2 is a plan view viewed from arrow X in FIG. 1, illustrating a part of the inner surface of the side mold 12 located on a lower side. In FIG. 2, a crosswise direction corresponds to a tire circumferential direction, an upper direction corresponds to an outside in the tire radial direction, and a lower direction corresponds to an inside of the tire radial direction. FIG. 3A is a cross-sectional view along line A-A in FIG. 2, and FIG. 3B illustrates, by a cross-sectional view similar to FIG. 3A, a state in which screws having flat head bottom surfaces, a stencil plate 3 and a mounting groove separate from one another before the stencil plate 3 is mounted.

The mold 10 includes: the tire molding surface 1 to be brought into contact with the outer surface of the tire T set in the cavity 16; a mounting groove 2 provided on the tire molding surface 1; the stencil plate 3 to be mounted on the mounting groove 2; and screws 4 having flat head bottom surfaces, the screws 4 being fixtures for fixing the stencil plate 3. The mounting groove 2 is provided by denting a part of the tire molding surface 1. In this embodiment, the mounting groove 2 is provided on the inner surface of the side mold 12, which is the tire molding surface 1.

The mounting groove 2 has a groove bottom surface 21, and a wall surface 22 erected from the groove bottom surface 21. A groove depth D2 of the mounting groove 2 may be 1.5 mm or less, or may be 1.3 mm or less. The groove depth D2 may be 1.0 mm or more, or may be 1.1 mm or more. On the groove bottom surface 21, female screw holes 23 for attaching the screws 4 thereto are provided. The stencil plate 3 is detachably attached to the tire molding surface 1 by using the screws 4. When an identification mark is changed, for example, when a year and week of manufacture are updated, the stencil plate 3 is detached from the tire molding surface 1, and another stencil plate provided with recesses for forming a different identification mark is attached thereto. Details of the screws 4 will be described later.

The stencil plate 3 is formed of a plate material made of metal such as stainless steel and aluminum. A thickness T3 of the stencil plate 3 may be 0.8 mm or less, or may be 0.4 mm or less. From a viewpoint of giving an appropriate strength to the stencil plate 3, the thickness T3 may be 0.2 mm or more, or may be 0.3 mm or more. The stencil plate 3 has an oblong shape in which a length L3 in the tire circumferential direction is larger than a width W3 in the tire radial direction. The stencil plate 3 is curved into a circular arc shape along the tire circumferential direction; however, without being limited to this, may have a shape extending linearly in a longitudinal direction LD.

The stencil plate 3 has a front surface 31 facing the cavity 16, a back surface 32 facing the groove bottom surface 21 of the mounting groove 2, and through holes 33 through which the screws 4 are inserted from the front surface 31 to the back surface 32. The front surface 31 is provided with first recesses 34 for forming a protruding identification mark on the outer surface of the tire T. At the time of vulcanization and molding, an outer surface of an unvulcanized tire is thrust against the front surface 31 of the stencil plate 3, and the identification mark is formed into a protruding shape by transcription. This embodiment illustrates an example in which the identification mark is formed of a character string that is “T T T”. The identification mark is not limited to characters, and may be symbols, a pattern and the like.

The first recesses 34 are formed to be dented by embossing from the front surface 31. A depth D34 of the first recesses 34 is set, for example, to 0.3 to 1.2 mm. The depth D34 is obtained while taking the front surface 31 as a reference. The back surface 32 is provided with first protrusions 35 corresponding to the first recesses 34. The first protrusions 35 are formed so as to correspond to the first recesses 34 which are formed to be dented. Hence, the first protrusions 35 are the first recesses 34 when viewed from the back surface 32 of the stencil plate 3. A protrusion amount H1 of the first protrusions 35 is substantially the same as the depth D34. The protrusion amount H1 is obtained while taking the back surface 32 as a reference.

On the front surface 31 of the stencil plate 3, in peripheries thereof including the through holes 33, second recesses 38 are provided. The bottom surfaces 41 of the heads of the screws 4 are disposed on the second recesses 38, and accordingly, the second recesses 38 are larger in area than the bottom surfaces 41 of the heads of the screws 4. On the back surface 32 of the stencil plate 3, in regions corresponding to the second recesses 38, second protrusions 39 protruding toward the groove bottom surface 21 of the mounting groove 2 are provided. The second protrusions 39 have flat surfaces 39a capable of being brought into surface contact with the groove bottom surface 21. A protrusion amount H2 of the second protrusions 39 is obtained while taking the back surface 32 as a reference. A magnitude of the protrusion amount H2 is equal to or larger than that of the protrusion amount H1 of the first protrusions 35. In other words, the protrusion amount H1 of the first protrusions 35 and the protrusion amount H2 of the second protrusions 39 satisfies: 0≤H2−H1. Thus, when the screws 4 inserted through the through holes 33 are tightened, the second protrusions 39 can reliably contact the groove bottom surface 21.

The screws 4 in which the bottom surface of the heads are flat are described. In the screws 4, the bottom surfaces 41 of the screw heads do not exhibit a tapered shape, and form flat surfaces perpendicular to an axial direction of the screws. Here, the flat surfaces refer to the state where the bottom surfaces are flat as a whole. For example, screws in which bottom surfaces are flat as a whole even if the bottom surfaces are locally provided with irregularities for loosening prevention are included in the screws having flat head bottom surfaces. Then, the second protrusions 39 have the flat surfaces capable of being brought into surface contact with the groove bottom surface 21, and accordingly, when the screws 4 are tightened, a force to sandwich the stencil plate 3 between the bottom surfaces 41 of the screw heads and the groove bottom surface 21 is gradually increased. At this time, the bottom surfaces 41 of the screw heads do not exhibit a tapered shape, and the stencil plate 3 does not have draws, and accordingly, the stencil plate 3 is not pulled into the groove bottom surface 21. That is, even if a worker tightens the screws 4 too strongly, the stencil plate 3 can be suppressed from approaching the groove bottom surface from an expected position. Moreover, torque management at the time of tightening the screws is made unnecessary, or a control value thereof is relaxed, and workability is improved.

Regarding the screw heads, FIG. 3A and FIG. 3B illustrate screws each of which has a constant diameter from the bottom surface 41 of the screw head to a top surface 42 of the screw head; however, the screw heads may be flange-attached screw heads in which such bottom surfaces 41 protrude in a radial direction of screws. Regarding the top surfaces 42 of the screw heads, FIG. 3A and FIG. 3B illustrate the screws having the flat top surfaces 42; however, the top surfaces 42 of the screw heads do not necessarily need to be flat, and for example, may have a shape in which centers of the top surfaces 42 of the screw heads swell. In terms of an exterior appearance of the tire, it is preferable that the top surfaces 42 of the screw heads be disposed so as to be flush with the tire molding surface 1; however, the top surfaces 42 are not limited to this. For example, such a configuration in which the top surfaces 42 of the screw heads protrude a little from the tire molding surface 1, and that such portions of a tire surface, which correspond to the screw heads, are formed as recesses, is allowable as an exterior appearance of the tire.

In this specification, the screws refer to general fastening elements, each of which has a rod on which a spiral groove is provided, and a head provided on one end of the rod, and the screws include bolts. In this embodiment, the top surfaces 42 of the screw heads have cross dents for receiving insertion of a tip end of a Phillips screwdriver. However, each of the top surfaces 42 may have a slotted dent for receiving insertion of a tip end of a slotted screwdriver, or may have a hexagonal dent for receiving insertion of a tip end of a hex wrench, and a shape of the dent for rotating the screw is not limited. Moreover, the dent related to the top surface 42 does not need to be present. For example, the screw head when viewed from above the screw head may be formed into a hexagonal shape, and such a hexagonal screw head may be rotated.

It is preferable that a value obtained by subtracting the protrusion amount H1 of the first protrusion 35 from the protrusion amount H2 of the second protrusion 39 be 0.3 (mm) or less, that is, satisfy H2−H1≤0.3. At the time of the vulcanization and the molding, the stencil plate 3 mounted on the mounting groove 2 is liable to be bent in a direction of being pressed by rubber and sinking. However, when such a numerical value relationship as described above is satisfied, the first protrusions 35 contact the groove bottom surface 21 due to a slight bend of the stencil plate 3, which follows the press by the rubber, thereby suppressing a further bend of the stencil plate 3. As a result, an occurrence of an unnecessary level difference on the outer surface of the tire can be suppressed.

Moreover, when H2−H1 is 0, all of the first protrusions 35 and the second protrusions 39 contact the groove bottom surface 21 without the bend of the stencil plate 3. Therefore, it is possible to further suppress the bend of the stencil plate 3. Note that such a configuration to satisfy 0<H2−H1 is also possible. In accordance with this, the second protrusions 39 are easy to contact the groove bottom surface 21 with priority over the first protrusions 35, and the stencil plate 3 can be effectively suppressed from approaching the groove bottom surface 21 from the expected position.

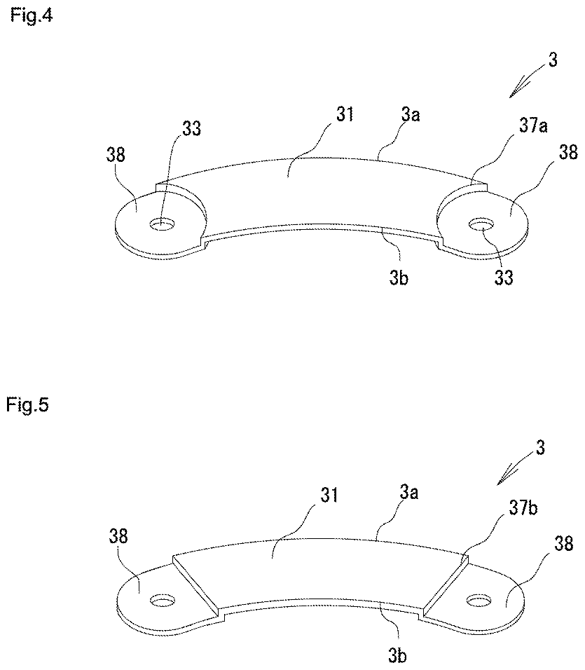

FIG. 4 illustrates a perspective view of the single stencil plate 3 according to the first embodiment. Note that the illustration of the identification mark is omitted. When the stencil plate 3 is viewed from the front surface 31, outer edges of the second recesses 38 include circular arcs 37a which connect long sides (3a, 3b) of the stencil plate 3 to each other, the long sides (3a, 3b) facing each other. A diameter of the circular arcs 37a is larger than a diameter of the screw heads. Note that, preferably, the diameter of the circular arcs 37a is equal to or a little larger than the diameter of the screw heads since spaces in the second recesses 38, which are formed between the circular arcs 37a and the screw heads and are not occupied by the heads of the screws having flat head bottom surfaces, are reduced, and an amount of rubber flowing into the second recesses 38 is reduced. It is preferable that centers of the circular arcs 37a substantially coincide with centers of the through holes 33.

It is preferable that a diameter of the through holes 33 into which the screws 4 are to be inserted be larger than a screw nominal diameter to an extent the screws 4 can be loosely fitted. Thus, the screws 4 can be fitted to the stencil plate 3 without any trouble. Moreover, since there are plays at positions at which the stencil plate 3 is fixed, the stencil plate 3 can be fixed without being bent even if positional accuracy of the female screw holes 23 of the mounting groove 2 is low. The suppression of the bend of the stencil plate 3 can reduce intrusion of extra rubber from a gap between the stencil plate 3 and the mounting groove 2, and the occurrence of the unnecessary level difference on the outer surface of the tire can be suppressed, whereby a possibility of degradation of the exterior appearance of the tire can be reduced.

Heretofore, in the female screw holes provided in the mounting groove, countersinks have been provided in order to partially house the draws of the stencil plate. Meanwhile, in this embodiment, no draws are provided on the second recesses 38 of the stencil plate 3, and the second recesses 38 are flat, and accordingly, the countersinks do not need to be provided in the female screw holes 23. Therefore, at the time of manufacturing the mold, not only countersink processing becomes unnecessary, but also a design can be made so that the stencil plate 3 can be loosely fitted to the mounting groove 2, and the bend of the stencil plate, which occurs in fixing the stencil plate 3, can be suppressed.

Here, the fact that the countersinks do not need to be provided is not a denial of an operation of attaching the stencil plate 3 and the screws 4 according to this embodiment. That is, the stencil plate 3 and the screws 4 according to this embodiment can also be applied to a conventional mold. Hence, a tire vulcanizing mold with countersinks does not need to be rebuilt to a tire vulcanizing mold without countersinks in conjunction with use of the stencil plate 3 and the screws 4 according to this embodiment. However, in order that the screw heads of the screws 4 cannot enter insides of the countersinks by tightening the screws, it is preferable to use screws in which bottom surfaces of screw heads are larger in diameter than the countersinks.

### Second Embodiment

A second embodiment is similar to the first embodiment except that the shape of the stencil plate is configured as follows, and accordingly, a description of common matters will be omitted. The same also applies to a third embodiment and a fourth embodiment. FIG. 5 illustrates a single stencil plate 3 according to the second embodiment. When the stencil plate 3 is viewed from a front surface 31, outer edges of second recesses 38 include straight lines 37b which connect long sides (3a, 3b) of the stencil plate 3 to each other, the long sides (3a, 3b) facing each other, and intersect substantially perpendicularly to the long sides. The straight lines 37b facilitate processing of the second recesses 38, in which processing accuracy is also high.

### Third Embodiment

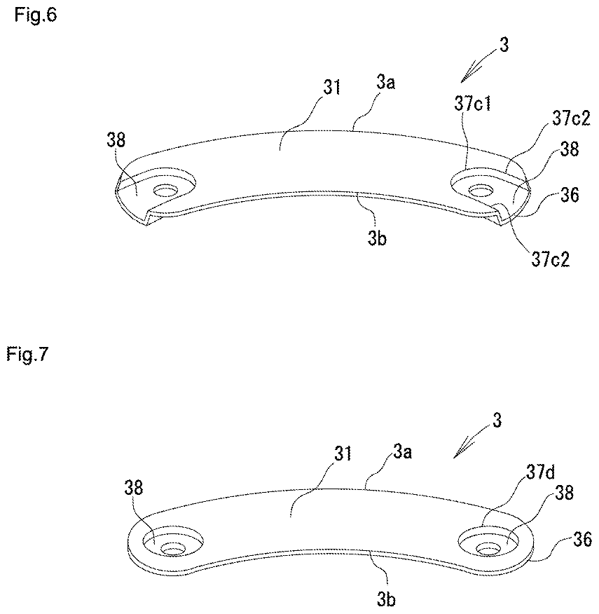

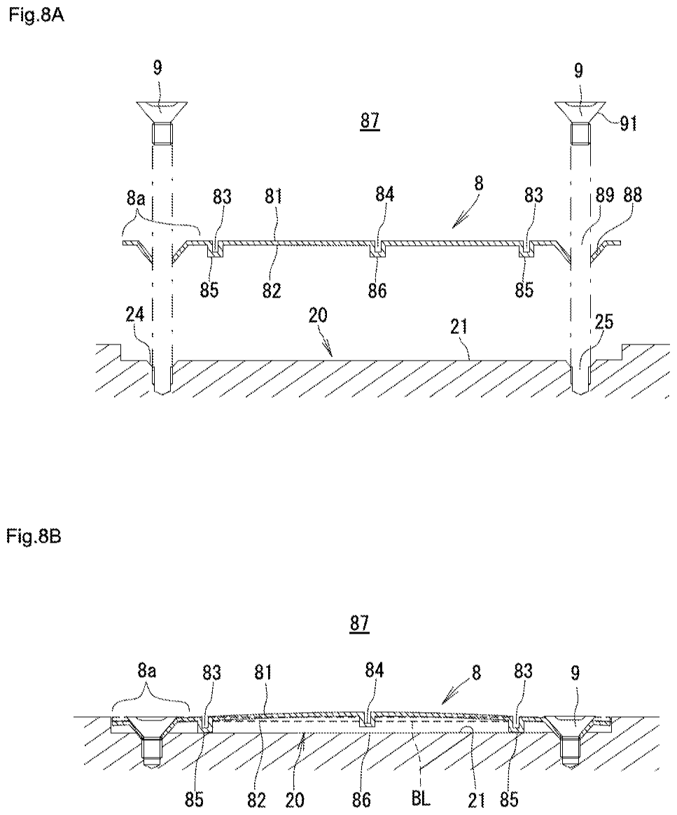

FIG. 6 illustrates a single stencil plate 3 according to the third embodiment. When the stencil plate 3 is viewed from a front surface 31, each of outer edges 37c of second recesses 38 has a U shape including: a circular arc 37c1; and a pair of sides (37c2, 37c2) individually extending from both end portions of the circular arc 37c1 along long sides (3a, 3b) of the stencil plate to an end portion outer edge 36 of the stencil plate. Thus, an area of each of the second recesses 38 which do not include screw heads, can be reduced, and an amount of rubber flowing into the second recess 38 can be reduced, whereby the possibility of degradation of the exterior appearance of the tire can be reduced.

### Fourth Embodiment

FIG. 7 illustrates a single stencil plate 3 according to a fourth embodiment. When the stencil plate 3 is viewed from a front surface 31, each of outer edges 37d of second recesses 38 has a closed shape of not contacting long sides (3a, 3b) and an end portion outer edge 36, which are an outer edge of the stencil plate. Thus, an extra gap caused by the second recess 38 is not formed between the stencil plate 3 and a mounting groove 2, and accordingly, intrusion of rubber from the gap is suppressed.

Moreover, it is preferable that the closed shape of the outer edge 37d of the second recess 38 be annular as illustrated in FIG. 7. Thus, a space in the second recess 38, which is not occupied by a head of a screw having a flat head bottom surface, is reduced, and an amount of rubber flowing into the second recess 38 is reduced. Hence, the possibility of degradation of the exterior appearance of the tire can be reduced.

In each of the embodiments mentioned above, the pair of second recesses provided on both end portions of the stencil plate are set to have the same shape; however, the second recesses are not limited to this. Hence, for example, a configuration can also be adopted, in which the second recess 38 having such a shape as illustrated in FIG. 6 is provided on one of the end portions of the stencil plate, and the second recess 38 having such a shape as illustrated in FIG. 7 is provided on the other end portion. As described above, it is possible to adopt a plurality of the embodiments in combination without particular limitations.

The present disclosure is not limited to the embodiments, and is improvable and modifiable in various ways within the scope without departing from the spirit of the present disclosure.

What is claimed is:

1. A tire vulcanizing mold comprising:
a tire molding surface to be brought into contact with an outer surface of a tire set in a cavity;
a mounting groove provided on the tire molding surface;
a stencil plate to be mounted on the mounting groove; and
a screw having a flat head bottom surface, the screw serving for fixing the stencil plate,
wherein the stencil plate includes: a front surface facing the cavity; a back surface facing a groove bottom surface of the mounting groove; and a through hole through which the screw is inserted from the front surface to the back surface,
the front surface is provided with: a first recess for forming a protruding identification mark on the outer surface of the tire; and a second recess on which the head bottom surface of the screw is disposed, the second recess being formed on a periphery of the through hole,
the back surface is provided with: a first protrusion protruding toward the groove bottom surface in a region corresponding to the first recess; and a second protrusion protruding toward the groove bottom surface in a region corresponding to the second recess and having a flat surface capable of being brought into surface contact with the groove bottom surface,
and when a protrusion amount of the first protrusion is H1 (mm), and a protrusion amount of the second protrusion is H2 (mm), 0≤H2−H1 is satisfied.

2. The tire vulcanizing mold according to claim 1, wherein H2−H1=0 is satisfied.

3. The tire vulcanizing mold according to claim 1, wherein H2−H1≤0.3 is satisfied.

4. The tire vulcanizing mold according to claim 1, wherein, when the stencil plate is viewed from the front surface, an outer edge of the second recess has a U shape including: a circular arc; and a pair of sides individually extending from both end portions of the circular arc along long sides of the stencil plate to an end portion outer edge of the stencil plate.

5. The tire vulcanizing mold according to claim 1, wherein, when the stencil plate is viewed from the front surface, an outer edge of the second recess has a closed shape of not contacting an outer edge of the stencil plate.

6. The tire vulcanizing mold according to claim 5, wherein the closed shape is annular.

7. The tire vulcanizing mold according to claim 1, when the stencil plate is viewed from the front surface, an outer edge of the second recess has a shape including a circular arc that connects long sides of the stencil plate, the long sides facing each other.

8. The tire vulcanizing mold according to claim 1, when the stencil plate is viewed from the front surface, an outer edge of the second recess has a shape including a straight line that connects long sides of the stencil plate, the long sides facing each other.

9. A method for manufacturing a tire, the method comprising a step of vulcanizing and molding a tire by using the tire vulcanizing mold according to claim 1.
